(19) United States
(12) Patent Application Publication
(10) Pub. No.: US 2016/0076688 A1
(43) Pub. Date: Mar. 17, 2016

(54) Tee fitting

(71) Applicant: Yu-Peng Chan, Changhua (TW)

(72) Inventor: Yu-Peng Chan, Changhua (TW)

(21) Appl. No.: 14/953,014

(22) Filed: Nov. 26, 2015

(51) Int. Cl. F16L 41/02

(52) U.S. Cl. CPC F16L 41/021

(57) ABSTRACT

A T-shaped pipe fitting includes three tubular branch lines each having a plurality of stepped sections of different outer diameters. Embodiments of the T-shaped pipe fitting are provided. Other pipe fittings having the characteristics of the T-shaped pipe fitting are also made possible. No reducer is required to connect pipes of different diameters to the T-shaped pipe fitting.

### BACKGROUND OF THE INVENTION

1. Field of the Invention

The invention relates to pipe fittings and more particularly to a T-shaped pipe fitting including three tubular branch lines each having stepped outer diameters

2. Description of Related Art

A first conventional T-shaped pipe fitting A having three ends Al of equal diameter is shown in FIG. 1. It is only applicable to connect three pipes of the same diameter. Alternatively, at least one additional reducer is required if the tee A is about to connect to at least one pipe having a different diameter.

A second conventional T-shaped pipe fitting B having three ends B1 of equal diameter is shown in FIG. 2. It is only applicable to connect three pipes of the same diameter. Alternatively, at least one additional reducer is required if the tee B is about to connect to at least one pipe having a different diameter.

Thus, the need for improvement still exists.

### SUMMARY OF THE INVENTION

It is therefore one object of the invention to provide a T-shaped pipe fitting comprising three tubular branch lines each including a plurality of sections of different outer diameters.

The above and other objects, features and advantages of the invention will become apparent from the following detailed description taken with the accompanying drawings.

### BRIEF DESCRIPTION OF THE DRAWINGS

FIG. 1 is a perspective view of a first conventional T-shaped pipe fitting;

FIG. 2 is a perspective view of a second conventional T-shaped pipe fitting;

FIG. 3 is a perspective view of a preferred embodiment of a T-shaped pipe fitting according to the invention;

FIGS. 4, 5, 6, 7 and 8 are top plan views in part section showing first, second, third, fourth, and fifth configurations of the tee fitting of FIG. 3 respectively;

FIG. 9 is a perspective view of a pipe coupling according to the invention;

FIG. 10 is a perspective view of a preferred embodiment of a pipe connection having a right-angled bend according to the invention;

FIG. 11 is a perspective view of a Y-shaped pipe fitting according to the invention;

FIG. 12 is a perspective view of another preferred embodiment of the tee fitting of FIG. 3 having a latch according to the invention;

FIG. 14 is a perspective view of still another preferred embodiment of the tee fitting of FIG. 3 according to the invention;

FIG. 15 is a perspective view of another preferred embodiment of the pipe connection having a right-angled bend of FIG. 10 according to the invention; and

FIG. 16 is a perspective view of yet another preferred embodiment of the tee fitting of FIG. 3 according to the invention.

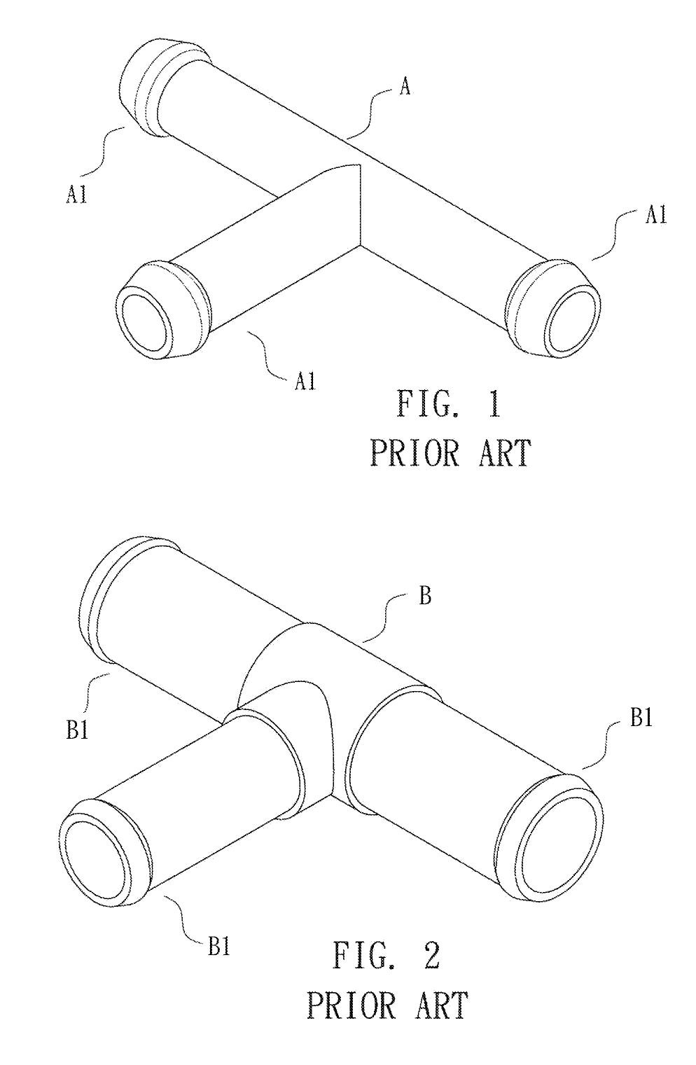

### DETAILED DESCRIPTION OF THE INVENTION

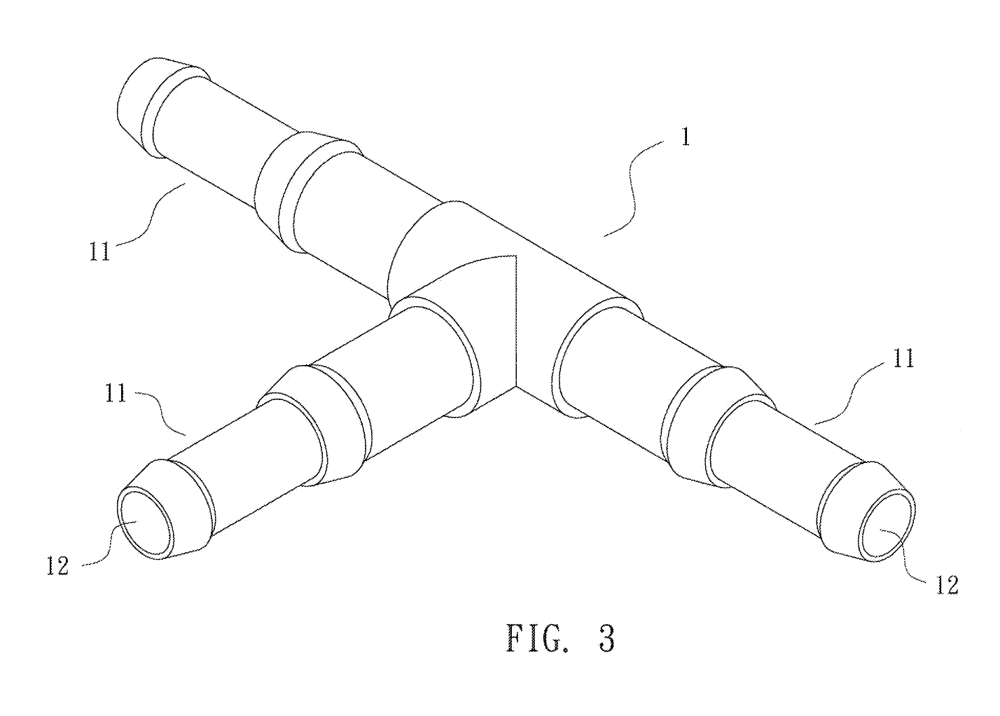

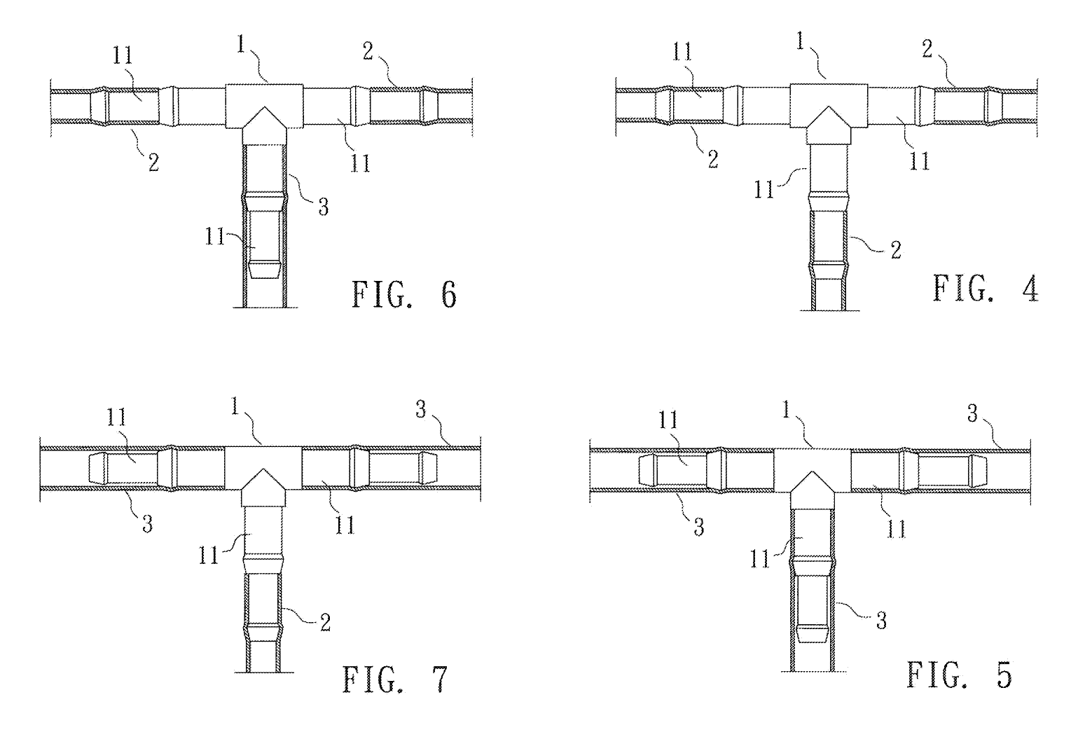

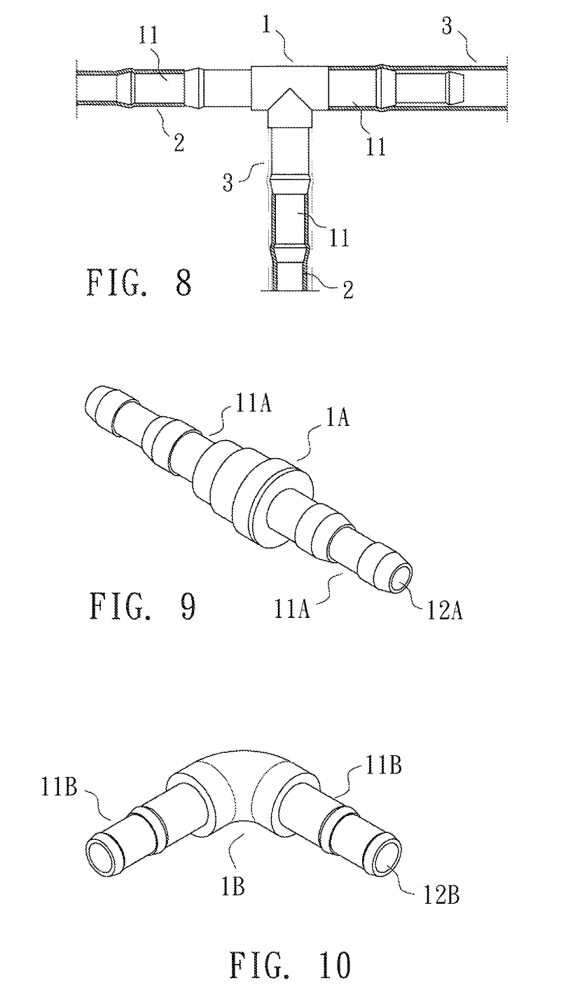

Referring to FIGS. 3 to 8, a T-shaped pipe fitting (tee fitting) 1 in accordance with a preferred embodiment of the invention comprises three tubular stepped-diameter branch lines 11 having an opening 12. The branch line 11 has two sections of different outer diameters. The branch lines 11 can be connected to pipes 2, pipes 3, or pipes 2, 3 in first, second, third, fourth, and fifth configurations of the tee fitting 1 (see FIGS. 4 to 8). In brief, no reducer is required to connect pipes of different diameters.

Referring to FIG. 9, a pipe coupling 1A having two tubular stepped-diameter branch lines 11A having an opening 12A in accordance with the invention is shown.

Referring to FIG. 10, an elbow fitting 1B having two tubular stepped-diameter branch lines 11B having an opening 12B in accordance with the invention is shown.

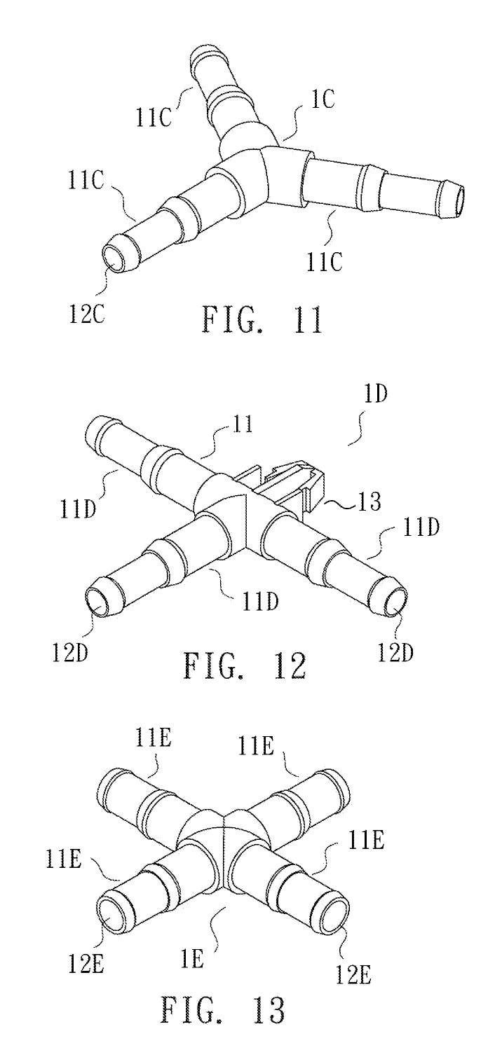

Referring to FIG. 11, a Y fitting 1C having three tubular stepped-diameter branch lines 11C having an opening 12C in accordance with the invention is shown.

Referring to FIG. 12, a tee fitting 1D having three tubular stepped-diameter branch lines 11D having an opening 12D, and a latch 13 in accordance with the invention is shown.

Referring to FIG. 13, a cross fitting 1E having fourth tubular stepped-diameter branch lines 11E having an opening 12E in accordance with the invention is shown.

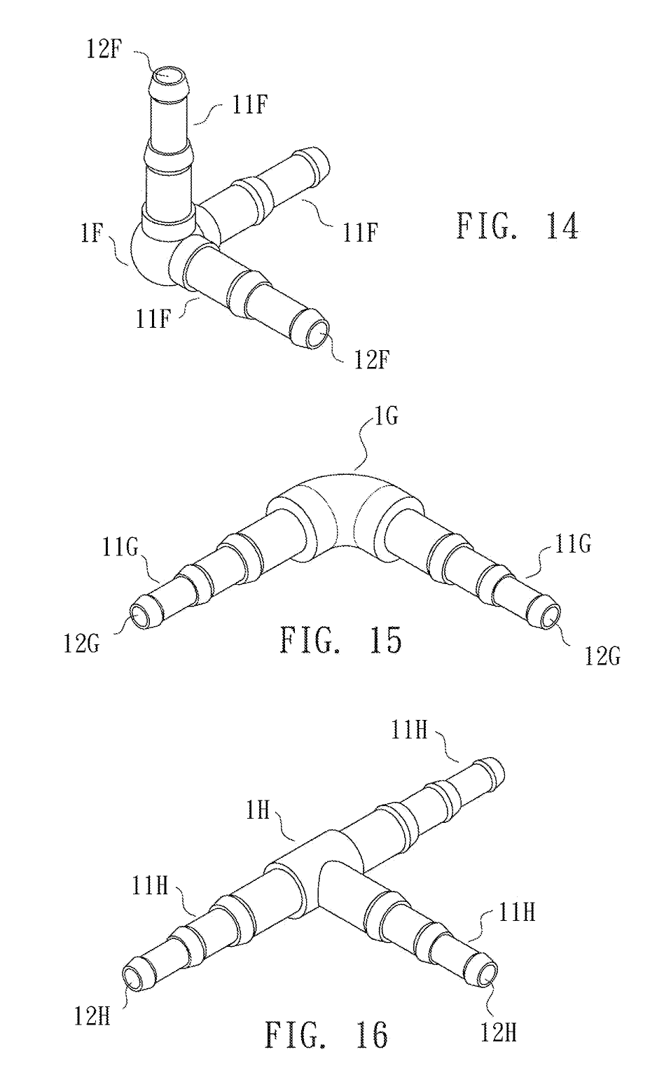

Referring to FIG. 14, a tee fitting 1F having three tubular stepped-diameter branch lines 11F having an opening 12F in which each branch line 11F is perpendicular to an adjacent branch line 11F in accordance with the invention is shown.

Referring to FIG. 15, an elbow fitting 1G having two tubular stepped-diameter branch lines 11G having an opening 12G in accordance with the invention is shown.

Referring to FIG. 16, a tee fitting 1H having three tubular stepped-diameter branch lines 11H having an opening 12H in accordance with the invention is shown. The branch line 11H is a three-section member.

While the invention has been described in terms of preferred embodiments, those skilled in the art will recognize that the invention can be practiced with modifications within the spirit and scope of the appended claims.

What is claimed is:

1. A T-shaped pipe fitting comprising:
three tubular branch lines each having a plurality of stepped sections of different outer diameters.
